(19) United States
(12) Patent Application Publication
(10) Pub. No.: US 2013/0234919 A1
(43) Pub. Date: Sep. 12, 2013

(54) DEVICES AND METHODS FOR DISCHARGING PIXELS HAVING OXIDE THIN-FILM TRANSISTORS

(71) Applicants: Wonjae Choi, Cupertino, CA (US); Chia-Ching Chu, San Jose, CA (US); Chun-Yao Huang, Cupertino, CA (US)

(72) Inventors: Wonjae Choi, Cupertino, CA (US); Chia-Ching Chu, San Jose, CA (US); Chun-Yao Huang, Cupertino, CA (US)

(73) Assignee: APPLE INC., Cupertino, CA (US)

(21) Appl. No.: 13/495,805

(22) Filed: Jun. 13, 2012

Related U.S. Application Data
(60) Provisional application No. 61/607,275, filed on Mar. 6, 2012.

(51) Int. Cl. G09G 3/36

(52) U.S. Cl. 345/92

(57) ABSTRACT

Methods and devices for discharging a pixel of an electronic display to be turned off are provided. In one example, a method may include supplying an activation signal to the pixel to activate the pixel. The method may also include supplying a data signal of substantially ground to a pixel electrode of the pixel. The method may include controlling a common electrode voltage of the pixel toward substantially ground. The method may also include removing the activation signal from the pixel after the common electrode voltage reaches substantially ground.

### CROSS REFERENCE TO RELATED APPLICATIONS

This application is a Non-Provisional patent application of U.S. Provisional Patent Application No. 61/607,275, entitled “Devices and Methods for Discharging Pixels Having Oxide Thin-Film Transistors”, filed Mar. 6, 2012, which is herein incorporated by reference.

### BACKGROUND

The present disclosure relates generally to electronic displays and, more particularly, to liquid crystal displays (LCDs) that can discharge pixels of the LCD having oxide thin-film transistors (TFTs) before the LCD is turned off to decrease image artifacts from occurring on the LCD.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Electronic displays, such as liquid crystal displays (LCDs), are commonly used in electronic devices such as televisions, computers, and phones. LCDs portray images by modulating the amount of light that passes through a liquid crystal layer within pixels of varying color. For example, by varying a voltage difference between a pixel electrode and a common electrode in a pixel, an electric field may result. The electric field may cause the liquid crystal layer to vary its alignment, which may ultimately result in more or less light being emitted through the pixel where it may be seen. By changing the voltage difference (often referred to as a data signal) supplied to each pixel, images may be produced on the LCD.

To store data representing a particular amount of light that is to be passed through pixels, gates of thin-film transistors (TFTs) in the pixels may be activated while the data signal is supplied to the pixels. Conventionally, TFTs may include an active layer that is typically fabricated using silicon-based materials, such as amorphous silicon (a-Si), poly-silicon (poly-Si), or microcrystalline silicon. Such silicon-based materials typically have a scaling limit, meaning that once they are scaled down to a certain size, they generally cannot be reduced any further in size without affecting operation. Accordingly, certain LCDs may be manufactured with oxide TFTs to overcome deficiencies found in TFTs fabricated using silicon-based materials.

However, the leakage current of oxide TFTs may be considerably lower than silicon-based materials. For example, the leakage current of oxide TFTs may be approximately 1000 times smaller than the leakage current of silicon-based materials. Since the pixel electrodes of the pixels of the LCD are not discharged before power is removed from the LCD, the remaining voltage on the pixels may be different from a desired low voltage and may cause an electric field that remains in place after the LCD is turned off. This electric field may continue to impact the liquid crystal layer of the pixels of the LCD while the LCD is off. It is believed that this electric field caused by the voltage on the pixel electrodes may result in image artifacts, such as flickering or image sticking, that could appear after the display is turned on again.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Embodiments of the present disclosure relate to devices and methods for discharging pixels of an electronic display having oxide thin-film transistors (TFTs) to store a low voltage (e.g., near-zero or zero volts) in the pixels and to reduce image artifacts from occurring after the display is turned on again. By way of example, a method for discharging a pixel of an electronic display to be turned off may include supplying an activation signal to the pixel to activate the pixel. The method may also include supplying a data signal of substantially ground to a pixel electrode of the pixel. The method may include controlling a common electrode voltage of the pixel toward substantially ground. The method may also include removing the activation signal from the pixel after the common electrode voltage reaches substantially ground.

Various refinements of the features noted above may be made in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a schematic block diagram of an electronic device with a liquid crystal display (LCD) that can discharge pixels of the LCD having oxide thin-film transistors (TFTs) before the LCD is turned off to decrease image artifacts from occurring on the LCD when the LCD is later turned back on, in accordance with an embodiment;

FIG. 2 is a perspective view of a notebook computer representing an embodiment of the electronic device of FIG. 1;

FIG. 3 is a front view of a handheld device representing another embodiment of the electronic device of FIG. 1;

FIG. 4 is a circuit diagram illustrating display circuitry used to discharge pixels of an LCD to reduce the occurrence of image artifacts when the LCD is turned back on, in accordance with an embodiment;

FIG. 5 is a circuit diagram illustrating circuitry of an electronic device having resistive devices for discharging pixels before an LCD is turned off to decrease the occurrence of image artifacts when the LCD is turned back on, in accordance with an embodiment;

FIG. 6 is a circuit diagram illustrating circuitry of an electronic device having switching devices used for discharging pixels before an LCD is turned off to decrease the occurrence of image artifacts when the LCD is turned back on, in accordance with an embodiment;

FIG. 7 is a circuit diagram illustrating circuitry of an electronic device having resistive devices and switching devices used for discharging pixels before an LCD is turned off to decrease the occurrence of image artifacts when the LCD is turned back on, in accordance with an embodiment;

FIG. 8 is a timing diagram illustrating a standard turn-off sequence of an LCD with oxide TFTs, which may result in the occurrence of image artifacts when the LCD is turned back on, in accordance with an embodiment;

FIG. 9 is a timing diagram illustrating a turn-off sequence used for an LCD with oxide TFTs to reduce the occurrence of image artifacts when the LCD is turned back on, in accordance with an embodiment; and

FIG. 10 is a flowchart describing a method for discharging a pixel of an LCD to be turned off to reduce image artifacts from occurring when the LCD is turned back on, in accordance with an embodiment.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As mentioned above, embodiments of the present disclosure relate to liquid crystal displays (LCDs) and electronic devices incorporating LCDs that employ a pixel discharging device, method, or combination thereof. Specifically, rather than turning off an electronic display that includes oxide thin-film transistors (TFTs) in a conventional manner, which could result in a residual voltage remaining on the pixels of the electronic display—which could in turn cause image artifacts—embodiments of the present disclosure may incorporate hardware, software, or a combination thereof for discharging pixels as part of the power down sequence of the display.

Specifically, to decrease the amount of residual voltage remaining on the pixels, an activation signal is applied to the pixels using oxide TFTs. With the activation signal applied, the gates of the TFTs remain open, thereby allowing current flow between the source and drain of the oxide TFTs. The gates of the TFTs are controlled to remain open until the pixels are discharged. After the pixels are discharged, the gates of the TFTs are controlled to close. As a result, it is believed that a residual voltage may be less likely to appear on the liquid crystal after the LCD is turned off and, accordingly, image artifacts may be less likely to occur when the LCD is turned back on.

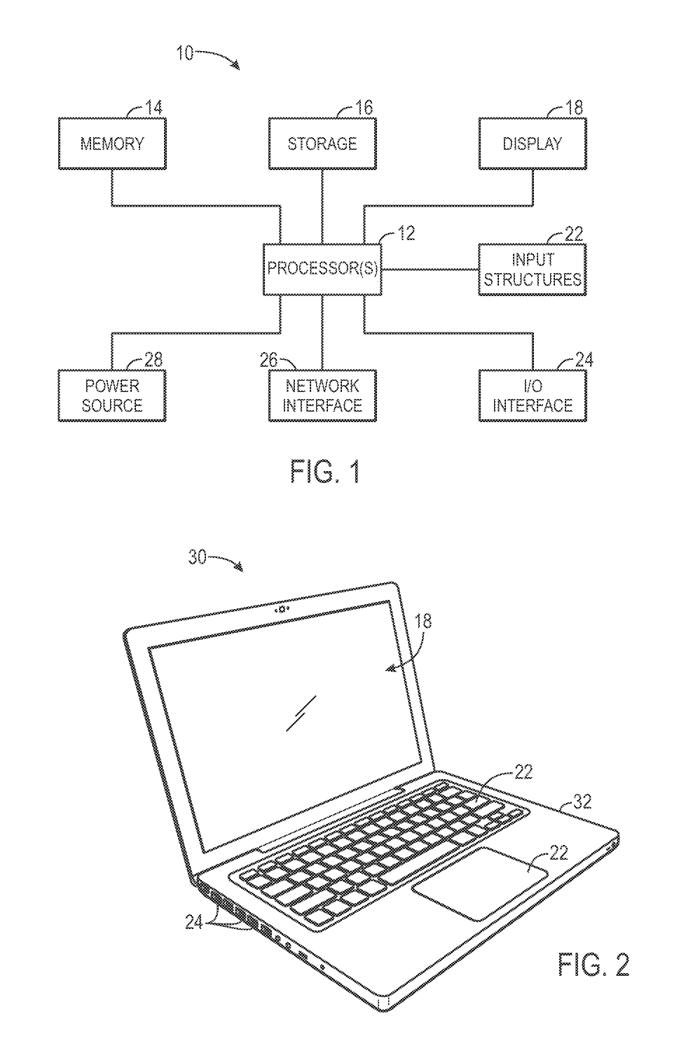

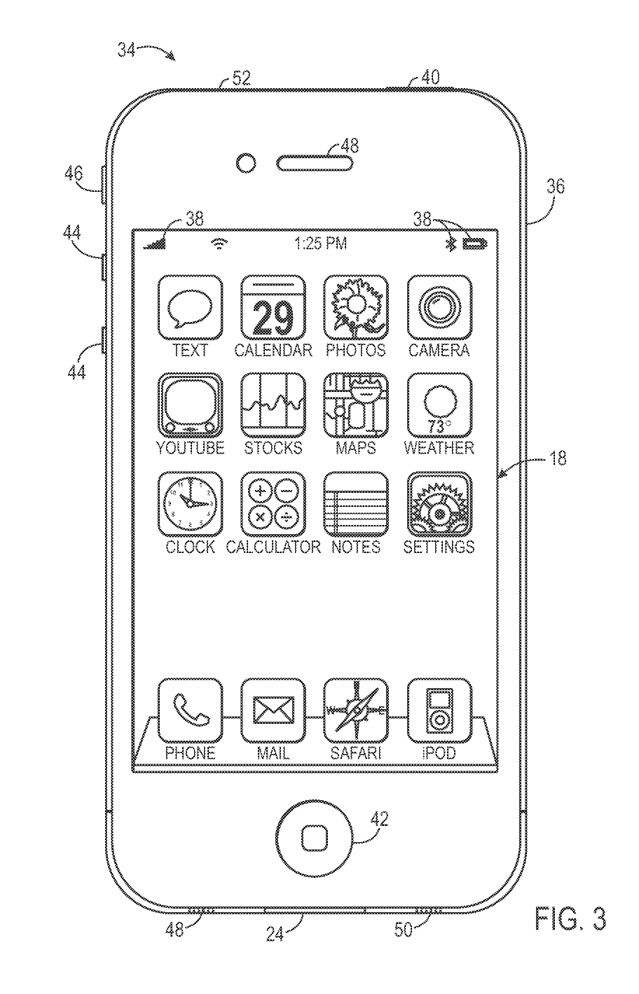

With the foregoing in mind, a general description of suitable electronic devices that may employ electronic displays having capabilities to discharge pixels of an LCD having oxide TFTs is described below. In particular, FIG. 1 is a block diagram depicting various components that may be present in an electronic device suitable for use with such a display. FIGS. 2 and 3 respectively illustrate perspective and front views of a suitable electronic device, which may be, as illustrated, a notebook computer or a handheld electronic device.

Turning first to FIG. 1, an electronic device 10 according to an embodiment of the present disclosure may include, among other things, one or more processor(s) 12, memory 14, nonvolatile storage 16, a display 18 having pixels with oxide TFTs, input structures 22, an input/output (I/O) interface 24, network interfaces 26, and a power source 28. The various functional blocks shown in FIG. 1 may include hardware elements (including circuitry), software elements (including computer code stored on a computer-readable medium) or a combination of both hardware and software elements. It should be noted that FIG. 1 is merely one example of a particular implementation and is intended to illustrate the types of components that may be present in the electronic device 10. As will be appreciated, when pixels are not discharged before the display 18 is turned off, a bias voltage may remain on the pixels. It is believed that this bias voltage could affect the liquid crystal, creating image artifacts on the display 18 for a long time (e.g., several minutes) after the display 18 is turned back on. As such, embodiments of the present disclosure may be employed to decrease the occurrence of image artifacts.

By way of example, the electronic device 10 may represent a block diagram of the notebook computer depicted in FIG. 2, the handheld device depicted in FIG. 3, or similar devices. It should be noted that the processor(s) 12 and/or other data processing circuitry may be generally referred to herein as “data processing circuitry.” This data processing circuitry may be embodied wholly or in part as software, firmware, hardware, or any combination thereof. Furthermore, the data processing circuitry may be a single contained processing module or may be incorporated wholly or partially within any of the other elements within the electronic device 10. As presented herein, the data processing circuitry may control the gates of the oxide TFTs of the electronic display 18 to allow the pixels to be discharged before the display 18 is turned off. Discharging the pixels of the display 18 may reduce the occurrence of image artifacts when the display 18 is later turned back on.

In the electronic device 10 of FIG. 1, the processor(s) 12 and/or other data processing circuitry may be operably coupled with the memory 14 and the nonvolatile memory 16 to execute instructions. Such programs or instructions executed by the processor(s) 12 may be stored in any suitable article of manufacture that includes one or more tangible, computer-readable media at least collectively storing the instructions or routines, such as the memory 14 and the nonvolatile storage 16. The memory 14 and the nonvolatile storage 16 may include any suitable articles of manufacture for storing data and executable instructions, such as random-access memory, read-only memory, rewritable flash memory, hard drives, and optical discs. Also, programs (e.g., an operating system) encoded on such a computer program product may also include instructions that may be executed by the processor(s) 12.

The display 18 may be a touch-screen liquid crystal display (LCD), for example, which may enable users to interact with a user interface of the electronic device 10. In some embodiments, the electronic display 18 may be a MultiTouch™ display that can detect multiple touches at once. As will be described further below, the electronic device 10 may include circuitry to control the discharge of pixels of the display 18 by keeping the gates of oxide TFTs activated until the pixels are substantially discharged.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interfaces 26. The network interfaces 26 may include, for example, interfaces for a personal area network (PAN), such as a Bluetooth network, for a local area network (LAN), such as an 802.11x Wi-Fi network, and/or for a wide area network (WAN), such as a 3G or 4G cellular network. The power source 28 of the electronic device 10 may be any suitable source of power, such as a rechargeable lithium polymer (Li-poly) battery and/or an alternating current (AC) power converter.

The electronic device 10 may take the form of a computer or other type of electronic device. Such computers may include computers that are generally portable (such as laptop, notebook, and tablet computers) as well as computers that are generally used in one place (such as conventional desktop computers, workstations and/or servers). In certain embodiments, the electronic device 10 in the form of a computer may be a model of a MacBook®, MacBook® Pro, MacBook Air®, iMac®, Mac® mini, or Mac Pro® available from Apple Inc. By way of example, the electronic device 10, taking the form of a notebook computer 30, is illustrated in FIG. 2 in accordance with one embodiment of the present disclosure. The depicted computer 30 may include a housing 32, a display 18, input structures 22, and ports of an I/O interface 24. In one embodiment, the input structures 22 (such as a keyboard and/or touchpad) may be used to interact with the computer 30, such as to start, control, or operate a GUI or applications running on computer 30. For example, a keyboard and/or touchpad may allow a user to navigate a user interface or application interface displayed on the display 18. Further, the display 18 may include oxide TFTs that are controlled to enable discharge of pixels of the display 18 before the display 18 is powered off.

FIG. 3 depicts a front view of a handheld device 34, which represents one embodiment of the electronic device 10. The handheld device 34 may represent, for example, a portable phone, a media player, a personal data organizer, a handheld game platform, or any combination of such devices. By way of example, the handheld device 34 may be a model of an iPod® or iPhone® available from Apple Inc. of Cupertino, Calif. In other embodiments, the handheld device 34 may be a tablet-sized embodiment of the electronic device 10, which may be, for example, a model of an iPad® available from Apple Inc.

The handheld device 34 may include an enclosure 36 to protect interior components from physical damage and to shield them from electromagnetic interference. The enclosure 36 may surround the display 18, which may display indicator icons 38. The indicator icons 38 may indicate, among other things, a cellular signal strength, Bluetooth connection, and/or battery life. The I/O interfaces 24 may open through the enclosure 36 and may include, for example, a proprietary I/O port from Apple Inc. to connect to external devices.

User input structures 40, 42, 44, and 46, in combination with the display 18, may allow a user to control the handheld device 34. For example, the input structure 40 may activate or deactivate the handheld device 34, the input structure 42 may navigate a user interface to a home screen, a user-configurable application screen, and/or activate a voice-recognition feature of the handheld device 34, the input structures 44 may provide volume control, and the input structure 46 may toggle between vibrate and ring modes. A microphone 48 may obtain a user's voice for various voice-related features, and a speaker 50 may enable audio playback and/or certain phone capabilities. A headphone input 52 may provide a connection to external speakers and/or headphones. As mentioned above, the display 18 may include oxide TFTs that are controlled to enable pixels of the display 18 to discharge before power is removed from the display 18.

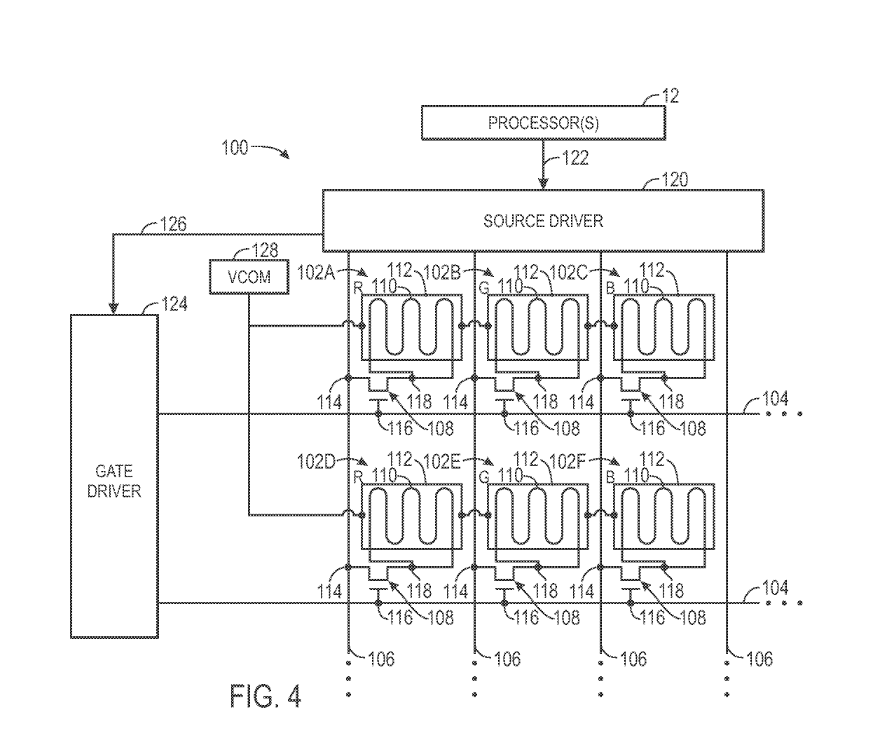

Among the various components of an electronic display 18 may be a pixel array 100, as shown in FIG. 4. As illustrated, FIG. 4 generally represents a circuit diagram of certain components of the display 18 in accordance with an embodiment. In particular, the pixel array 100 of the display 18 may include a number of unit pixels 102 disposed in a pixel array or matrix. In such an array, each unit pixel 102 may be defined by the intersection of rows and columns, represented by gate lines 104 (also referred to as scanning lines), and source lines 106 (also referred to as data lines), respectively. Although only six unit pixels 102, referred to individually by the reference numbers 102A-102F, respectively, are shown for purposes of simplicity, it should be understood that in an actual implementation, each source line 106 and gate line 104 may include hundreds or thousands of such unit pixels 102. Each of the unit pixels 102 may represent one of three subpixels that respectively filters only one color (e.g., red, blue, or green) of light. For purposes of the present disclosure, the terms “pixel,” “subpixel,” and “unit pixel” may be used largely interchangeably.

In the presently illustrated embodiment, each unit pixel 102 includes an oxide thin film transistor (TFT) 108 for switching a data signal supplied to a respective pixel electrode 110. The potential stored on the pixel electrode 110 relative to a potential of a common electrode 112, which may be shared by other pixels 102, may generate an electrical field sufficient to alter the arrangement of a liquid crystal layer of the display 18. In the depicted embodiment of FIG. 4, a source 114 of each oxide TFT 108 may be electrically connected to a source line 106 and a gate 116 of each oxide TFT 108 may be electrically connected to a gate line 104. A drain 118 of each oxide TFT 108 may be electrically connected to a respective pixel electrode 110. Each oxide TFT 108 may serve as a switching element that may be activated and deactivated (e.g., turned on and off) for a period of time based on the respective presence or absence of a scanning or activation signal on the gate lines 104 that are applied to the gates 116 of the oxide TFTs 108.

When activated, an oxide TFT 108 may store the image signals received via the respective source line 106 as a charge upon its corresponding pixel electrode 110. As noted above, the image signals stored by the pixel electrode 110 may be used to generate an electrical field between the respective pixel electrode 110 and a common electrode 112. This electrical field may align the liquid crystal molecules within the liquid crystal layer to modulate light transmission through the pixel 102. Thus, as the electrical field changes, the amount of light passing through the pixel 102 may increase or decrease. In general, light may pass through the unit pixel 102 at an intensity corresponding to the applied voltage from the source line 106.

The display 18 also may include a source driver integrated circuit (IC) 120, which may include a processor, microcontroller, or application specific integrated circuit (ASIC), that controls the display pixel array 100 by receiving image data 122 from the processor(s) 12 and sending corresponding image signals to the unit pixels 102 of the pixel array 100. It should be understood that the source driver 120 may be a chip-on-glass (COG) component on a TFT glass substrate, a component of a display flexible printed circuit (FPC), and/or a component of a printed circuit board (PCB) that is connected to the TFT glass substrate via the display FPC. Further, the source driver 120 may include any suitable article of manufacture having one or more tangible, computer-readable media for storing instructions that may be executed by the source driver 120.

The source driver 120 also may couple to a gate driver integrated circuit (IC) 124 that may activate or deactivate rows of unit pixels 102 via the gate lines 104. As such, the source driver 120 may provide timing signals 126 to the gate driver 124 to facilitate the activation/deactivation of individual rows (i.e., lines) of pixels 102. In other embodiments, timing information may be provided to the gate driver 124 in some other manner. The display 18 may include a Vcom source 128 to provide a Vcom output to the common electrodes 112. In some embodiments, the Vcom source 128 may supply a different Vcom to different common electrodes 112 at different times. In other embodiments, the common electrodes 112 all may be maintained at the same potential (e.g., a ground potential) while the display 18 is on.

When pixel electrodes 110 are not discharged before the display 18 is turned off, a bias voltage may remain on the pixel electrodes 110. It is believed that this bias voltage could affect the liquid crystal, creating image artifacts on the display 18 for a long time (e.g., several minutes) after the display 18 is turned back on. Accordingly, the oxide TFTs 108 are controlled to allow discharge the pixel electrodes 110 during the display 18 turn-off sequence to inhibit image artifacts from appearing on the display 18, such as when the display 18 is turned on after previously being turned off. As a result of discharging the pixel electrodes 110, the bias voltage on the pixel electrodes 110 when the display 18 is turned off may be low, or near zero.

Oxide TFTs 108 may have considerably lower leakage current than amorphous silicon (a-Si) TFTs as shown in the following table:

TABLE 1

| | a-Si TFT | oxide TFT |
|---|---|---|
| Threshold Voltage | <=0 V | >2 V |
| Leakage Current | 1E−11 < loff < 1E−10 | <1E−14 |
| (loff) where Vgs = 0 | | |
| loff where Vgs < 0 | <1E−11 | <1E−14 |

As listed in TABLE 1, a-Si TFTs differ from oxide TFTs 108 in multiple ways. For example, the gate threshold voltage of a-Si TFTs may be generally less than or equal to zero, while the gate threshold voltage for oxide TFTs 108 may be generally greater than two volts. Further, the leakage current of the oxide TFTs 108 may be approximately 1000 times smaller than the leakage current of a-Si TFTs. Accordingly, when the gate 116 of an oxide TFT 108 is not activated (e.g., the gate voltage is lower than the gate threshold voltage), very little current may flow between the source 114 and the drain 118 of the oxide TFT 108. As such, the pixels 102 may be inhibited from discharging through the oxide TFTs 108 when the gates 116 are not activated. Therefore, in certain embodiments, an electronic device 10 using oxide TFTs 108 may be configured to keep the gates 116 of the oxide TFTs 108 activated for a sufficient amount of time to allow the pixels 102 of the display 18 to discharge through the oxide TFTs 108.

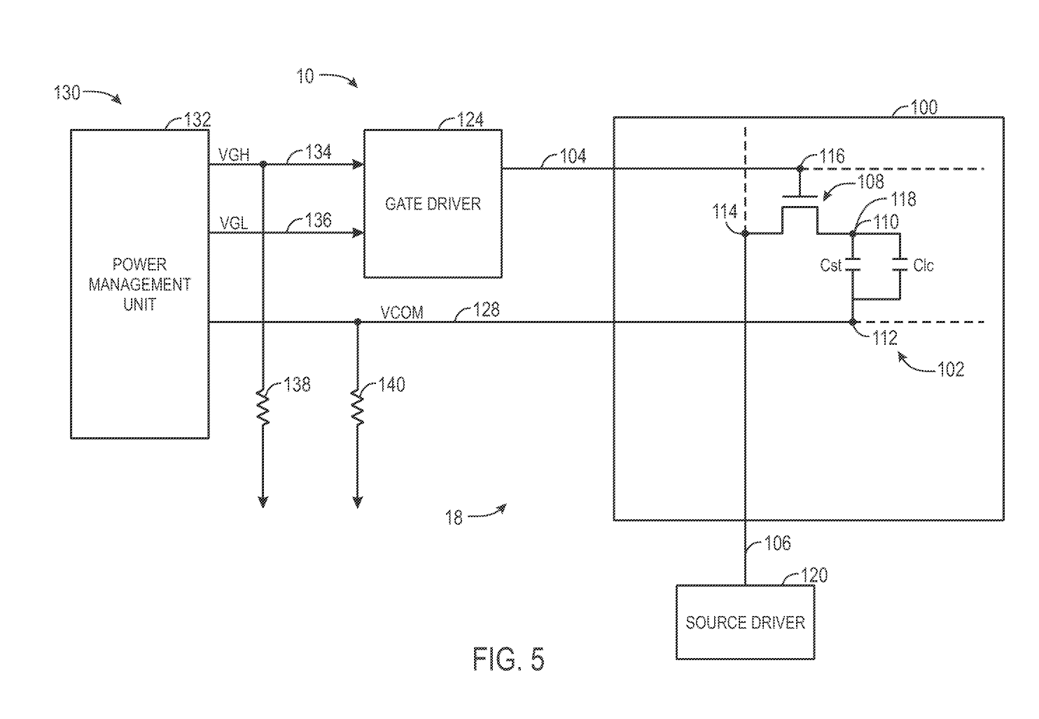

There are many ways to configure the circuitry of the electronic device 10 so that pixels 102 of the electronic display 18 may be discharged before gates 116 of the oxide TFTs 108 are deactivated. FIG. 5 generally represents one embodiment of a circuit diagram 130 of certain components of the electronic device 10 used for discharging pixels prior to deactivating gates 116 of oxide TFTs 108 before the display 18 is turned off to decrease the occurrence of image artifacts when the display 18 is turned back on. In particular, the electronic device 10 includes a power management unit 132. The power management unit 132 is used to manage the power of the electronic device 10 and may control when power is applied to, or removed from, other components of the electronic device 10. For example, the power management unit 132 provides a high gate voltage (VGH) 134 and a low gate voltage (VGL) 134 to the gate driver 124. As will be appreciated, the gate driver 124 may use the VGH 134 to apply an activation voltage to the gate lines 104, while the gate driver 124 may use the VGL 136 to apply a deactivation voltage to the gate lines 104. As such, the gate driver 124 may be configured to couple together either the VGH 134 or the VGL 136 to the gate line 104.

A first resistive device 138 (e.g., pull-down resistor) couples the VGH 134 to ground, while a second resistive device 140 (e.g., pull-down resistor) couples the Vcom source 128 to ground. Each of the first and second resistive devices 138 and 140 may be designed with a resistance suitable for discharging the gate 116 and the pixels 102 respectively, as explained in detail below. During normal operation of the electronic device 10, the first and second resistive devices 138 and 140 may have little effect on the operation of the electronic device 10. For example, a voltage applied to VGH 134 is also applied to the first resistive device 138 resulting in power dissipation; however, this power dissipation may generally be small (e.g., when the resistance of the first resistive device 138 is large). As another example, a voltage on the Vcom source 128 is also applied to the second resistive device 140 resulting in power dissipation. Again, this power dissipation may generally be small (e.g., when the resistance of the second resistive device 140 is large).

During a power off sequence of the electronic device 10, the power management unit 132 may remove power from the display 18. For example, the power management unit 132 may cause the connection between the power management unit 132 and each of the VGH 134, the VGL 136, and the Vcom source 128 to operate as an open circuit. Further, during the power off sequence, the gate driver 124 may be configured to couple the VGH 134 to the gate line 104. In addition, the source driver 120 may be configured to couple the source line 106 to ground. Therefore, voltage that remains on the gate 116 may be discharged via the gate line 104, the VGH 134, and the pull-down first resistive device 138. The discharge rate may be based on the resistance of the first resistive device 138 and a charge that may be stored between the gate 116 and the source 114. As will be appreciated, as long as the voltage applied to the gate line 104 is greater than the threshold voltage of the gate 116, the oxide TFT 108 will remain activated.

In the present embodiment, the pixel 102 may discharge concurrently with the gate 116 (e.g., the activation voltage and the common electrode 112 voltage may be controlled concurrently). Specifically, while the gate 116 remains activated, the charge stored on liquid crystal capacitor (Clc) and the storage capacitor (Cst) may be discharged via the following path: the Vcom source 128 coupled to ground via the second resistive device 140, the common electrode 112 coupled to the Vcom source 128, the pixel electrode 110 coupled to the drain 118, the source 114 coupled to the source line 106, and the source line 106 coupled to ground. The discharge rate of the pixel 102 may be based on the resistance of the second resistive device 140 and the charge stored on Clc and Cst. After the gate 116 is deactivated, the charge stored in the pixel 102 may still discharge through the same path; however, the discharge rate will be limited to the leakage current of the oxide TFT 108, resulting in a slow discharge. As such, to completely discharge the pixel 102, the resistance of the first and second resistive devices 138 and 140 should be selected so that the pixel 102 will completely discharge before the voltage on the gate line 104 drops below the threshold voltage of the oxide TFT 108. By discharging the pixel 102 during the power off sequence of the display 18, image artifacts occurring on the display 18 may be reduced or eliminated.

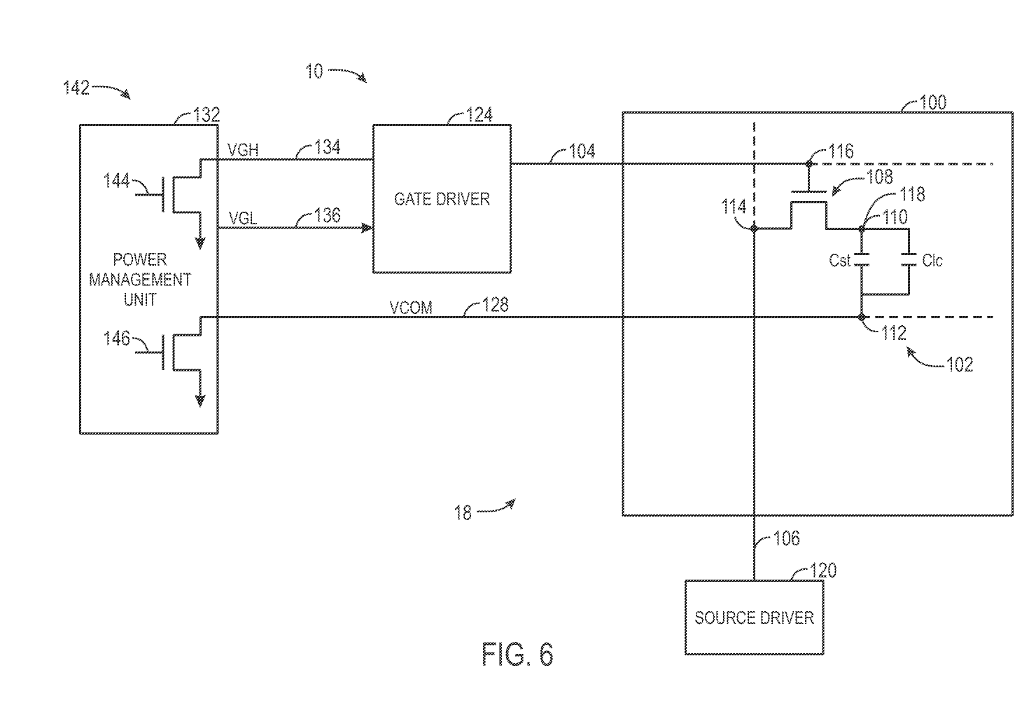

The discharge of pixels 102 of the electronic display 18 may be controlled using switching devices within the power management unit 132. Accordingly, FIG. 6 generally represents an embodiment of a circuit diagram 142 of the electronic device 10 using switching devices for discharging pixels 102 before the display 18 is turned off to decrease the occurrence of image artifacts when the display 18 is turned back on. The power management unit 132 includes a first control circuitry 144 and a second control circuitry 146. The first control circuitry 144 is configured to selectively couple the VGH 134 to ground, while the second control circuitry 146 is configured to selectively couple the Vcom source 128 to ground. As illustrated, in the present embodiment, the first control circuitry 144 and the second control circuitry 146 may each include a FET; however, in other embodiments, the first control circuitry 144 and the second control circuitry 146 may include any suitable output producing devices, such as any type of switching device or solid state device.

Using the first control circuitry 144 and the second control circuitry 146, the power management unit 132 may control the timing of the pixel 102 discharge. Specifically, during a power off sequence of the electronic device 10, the power management unit 132 may remove power from the display 18. Further, the gate driver 124 may be configured to couple the VGH 134 to the gate line 104. In addition, the source driver 120 may be configured to couple the source line 106 to ground. Accordingly, a voltage remaining on the gate 116 may be discharged by the power management unit 132 activating the first control circuitry 144 to enable current flow between the VGH 134 and ground. Furthermore, the pixel 102 may be discharged by the power management unit 132 activating the second control circuitry 146 to enable current flow between the Vcom source 128 and ground.

As discussed above, to efficiently discharge the pixel 102, the pixel 102 should be discharged prior to deactivating the gate 116. Therefore, during the power off sequence, the power management unit 132 may activate the second control circuitry 146 to discharge the pixel 102. After the pixel 102 is discharged, the power management unit 132 may activate the first control circuitry 144 to discharge any charge remaining on the gate 116. Using such a sequence, the pixel 102 may be discharged as part of the power down sequence of the display 18 to reduce the occurrence of image artifacts appearing on the display 18 when the display is turned on at a later time.

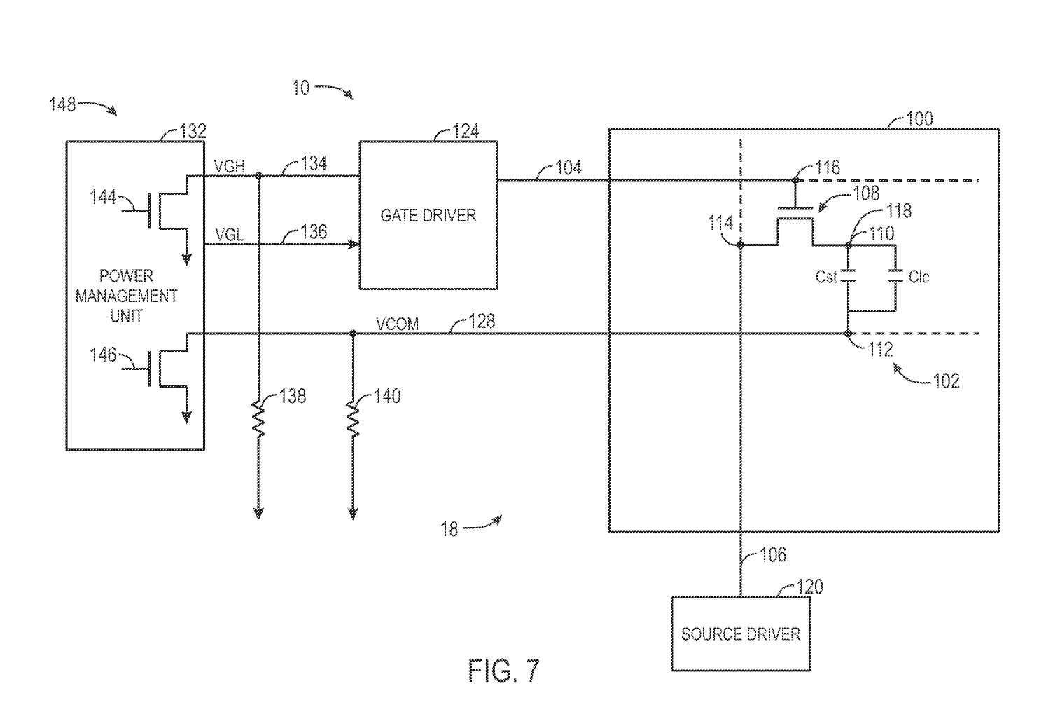

The discharge of pixels 102 of the electronic display 18 may also be controlled by a combination of resistive devices and switching device. Specifically, FIG. 7 is a circuit diagram 148 illustrating the electronic device 10 having the first and second resistive device 138 and 140 and the first and second control circuitry 144 and 146 for discharging pixels 102 before the display 18 is turned off to decrease the occurrence of image artifacts when the display 18 is turned back on. During a power off sequence, the second resistive device 140 may generally provide a predetermined discharge rate for discharging the pixel 102. Furthermore, the power management unit 132 may provide additional control to the rate of pixel 102 discharge using the second control circuitry 146. For example, the power management unit 132 may use the second control circuitry 146 to increase and/or decrease the rate of pixel 102 discharge. In addition, the first resistive device 138 may generally provide a predetermined discharge rate for discharging any charge remaining on the gate 116. Again, the power management unit 132 may provide additional control to the rate of gate 116 discharge using the first control circuitry 144. As such, the pixel 102 may be discharged during the turn-off sequence of the display 18.

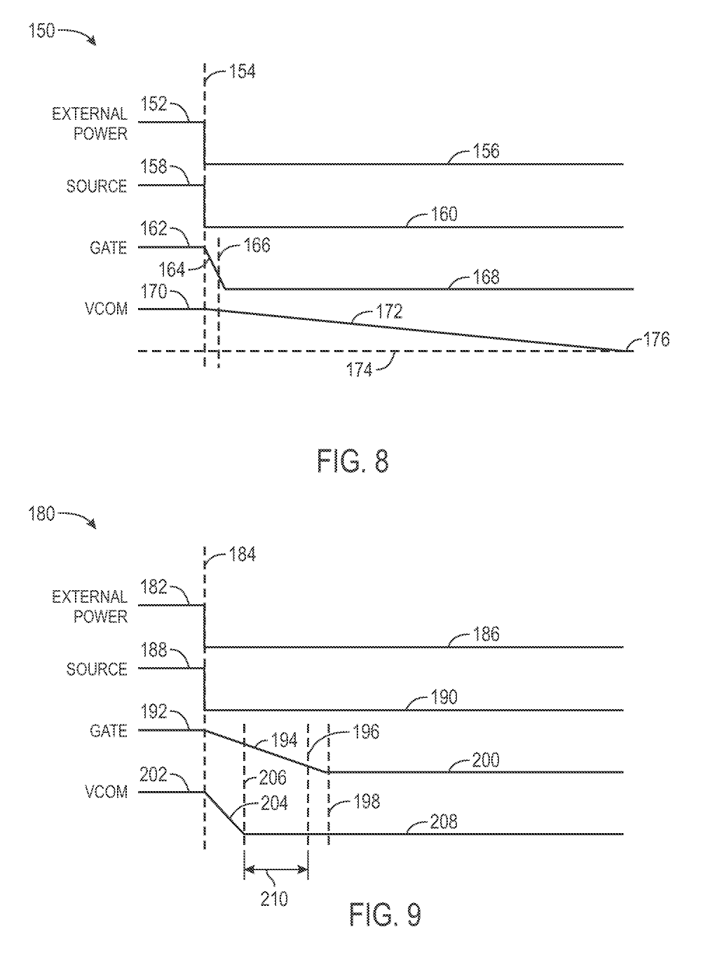

If the gates 116 of the oxide TFTs 108 are deactivated prior to completely discharging the pixels 102 of the display 18, the pixels 102 may store a charge for a long period of time (e.g., many minutes). FIG. 8 illustrates one embodiment of a timing diagram 150 that shows a standard turn-off sequence of the display 18 with oxide TFTs 108. As illustrated, external power may be applied to the display 18, as shown by segment 152. At a time 154, the external power may be removed from the display 18, as shown by segment 156. Pixel data may be supplied to the source line 106, as shown by segment 158, until the external power is removed at the time 154. After the external power is removed, the source line 106 may be grounded (e.g., apply a low voltage, near-zero voltage, black voltage, zero volts, etc.), as shown by segment 160.

A voltage is applied to the gate line 104 to activate the gate 116, as shown by segment 162, until the external power is removed at the time 154. After the time 154, the voltage applied to the gate line 104 is reduced and/or discharged during segment 164. At a time 166, the voltage on the gate line 104 is at the threshold voltage for the oxide TFT 108, so that after the time 166, the gate 116 is not activated. During segment 168, the voltage on the gate line 104 remains at a low voltage, such as zero or ground. A voltage present on the Vcom source 128 is shown by segment 170. At the time 154, the voltage present on the Vcom source 128 may begin to discharge toward zero, near-zero, or ground, as shown by segment 172.

As will be appreciated, the voltage present on the Vcom source 128 may be associated with a charge stored in the pixels 102. In certain embodiments, the voltage present on the Vcom source 128 may discharge at a faster rate between the times 154 and 166, until the voltage on the gate line 104 passes the threshold voltage. Further, the discharge of the voltage present on the Vcom source 128 may be limited after the time 166 to the leakage current of the oxide TFTs 108. Accordingly, the voltage present on the Vcom source 128 may indicate that a voltage remains on the pixels 102. This voltage present on the pixels 102 may remain for a long period of time (e.g., the duration of segment 172) and may result in image artifacts occurring when the display 18 is turned back on. The voltage present on the Vcom source 128 may eventually reach ground 174 (or a low voltage, near-zero voltage, black voltage, zero volts, etc.), as shown by segment 176. It should be noted that a “ground” voltage or a “black” voltage as used herein may be a voltage that produces a dark pixel (e.g., the darkest pixel voltage).

In certain embodiments, the pixels 102 may be discharged through the oxide TFTs 108 if a voltage on the gates 116 of the oxide TFTs 108 is maintained above a threshold voltage. FIG. 9 illustrates one embodiment of a timing diagram 180 that shows a turn-off sequence used for the display 18 having oxide TFTs 108 to reduce the occurrence of image artifacts when the display 18 is turned back on at a later time. As illustrated, external power may be applied to the display 18, as shown by segment 182. At a time 184, the external power may be removed from the display 18, as shown by segment 186. Pixel data may be supplied to the source line 106, as shown by segment 188, until the external power is removed at the time 184. After the external power is removed, the source line 106 may be grounded (e.g., apply a low voltage, near-zero voltage, black voltage, zero volts, etc.), as shown by segment 190.

A voltage is applied to the gate line 104 to activate the gate 116, as shown by segment 192, until the external power is removed at the time 184. After the time 184, the voltage applied to the gate line 104 is reduced and/or discharged during segment 194. At a time 196, the voltage on the gate line 104 is at the threshold voltage for the oxide TFT 108, so that after the time 196, the gate 116 is not activated. At a time 198, the voltage on the gate line 104 reaches ground, a low voltage, a near-zero voltage, a black voltage, or zero volts. During segment 200, the voltage on the gate line 104 remains at the voltage reached at time 198 (e.g., ground). A voltage present on the Vcom source 128 is shown by segment 202. At the time 184, the voltage present on the Vcom source 128 may begin to discharge toward zero, near-zero, or ground, as shown by segment 204.

As will be appreciated, the voltage present on the Vcom source 128 may be associated with a charge stored in the pixels 102. At a time 206, the voltage present on the Vcom source 128 may reach ground (or a low voltage, near-zero voltage, black voltage, zero volts etc.) where the voltage remains, as shown by segment 208. As illustrated, the voltage on the Vcom source 128 (e.g., pixel 102 voltage) discharges before time 206. Accordingly, the pixels 102 discharge before the time 196 where the voltage on the gate line 104 passes the threshold voltage of the gate 116. As such, there is a time difference 210, of greater than or equal to zero, between the time 206 and the time 196. Therefore, the pixels 102 are able to discharge, decreasing the occurrence of image artifacts that may occur when the display is turned on at a later time.

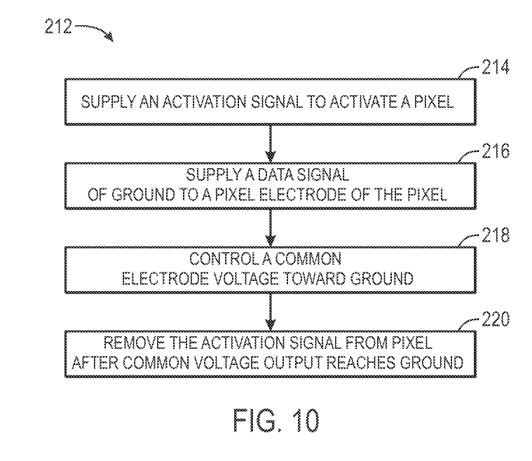

As presented above, the display 18 is shut down using a series of operations that may inhibit image artifacts from appearing when the display 18 is subsequently turned back on. FIG. 10 illustrates one embodiment of a method 212 for discharging a pixel 102 of the display 18 before power is removed from the display 18. An activation signal is supplied to the pixel 102 to activate the pixel (block 214). For example, the activation signal may be supplied to the pixel 102 via the oxide TFT 108. Further, a data signal of substantially ground (e.g., a low voltage, near-zero voltage, black voltage, zero volts, etc.) is supplied to the pixel electrode 110 of the pixel 102 (block 216). The common electrode 112 voltage of the pixel 102 is controlled toward substantially ground (block 218). In certain embodiments, the common electrode 112 voltage of the pixel 102 may be controlled from a voltage that is not zero, or not substantially ground. As will be appreciated, the common electrode 112 voltage may be controlled using a resistive device, a solid state device, or another suitable device. Further, the common electrode 112 voltage may be controlled via the power management unit 132. The activation signal is removed from the pixel 102 after the common electrode 112 voltage of the pixel 102 reaches substantially ground (block 220). In certain embodiments, the activation signal may be removed from the pixel 102 using a resistive device, a solid state device, or another suitable device. It should be noted that removing the activation signal may mean decreasing the activation signal below the threshold voltage for the oxide TFT 108. In some embodiments, the activation signal is controlled toward the threshold voltage at approximately the same time that the common electrode 112 voltage is controlled toward substantially ground. In certain embodiments, the activation signal is controlled to be above the threshold voltage until the common electrode 112 voltage reaches substantially ground. Technical effects of the present disclosure include, among other things, discharging pixels 102 that use oxide TFTs 108 prior to the display 18 and/or the electronic device 10 being turned off. The pixels 102 are discharged before the gate 116 voltage of the oxide TFTs 108 are deactivated. Accordingly, image artifacts, which may result from pixels 102 not being discharged, may be reduced and/or eliminated.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A method for discharging a pixel of an electronic display to be turned off comprising:
supplying an activation signal to the pixel to activate the pixel;
supplying a data signal of substantially ground to a pixel electrode of the pixel;
controlling a common electrode voltage of the pixel toward substantially ground; and
removing the activation signal from the pixel after the common electrode voltage reaches substantially ground.

2. The method of claim 1, wherein supplying the activation signal to the pixel comprises supplying the activation signal using an oxide thin-film transistor.

3. The method of claim 1, wherein controlling the common electrode voltage of the pixel comprises controlling the common electrode voltage of the pixel from a voltage that is not substantially ground.

4. The method of claim 1, wherein controlling the common electrode voltage of the pixel toward substantially ground comprises discharging the pixel using a resistive device, a solid state device, or a combination thereof.

5. The method of claim 1, wherein controlling the common electrode voltage of the pixel toward substantially ground comprises using a power management unit to control the common electrode voltage.

6. The method of claim 1, wherein removing the activation signal from the pixel comprises removing the activation signal using a resistive device, a solid state device, or a combination thereof.

7. The method of claim 1, wherein removing the activation signal from the pixel comprises decreasing an activation voltage below an activation threshold voltage.

8. The method of claim 1, comprising controlling an activation signal voltage of the activation signal toward an activation threshold voltage while controlling the common electrode voltage of the pixel toward substantially ground.

9. The method of claim 1, comprising controlling an activation signal voltage of the activation signal to be above an activation threshold voltage until the common electrode voltage reaches substantially ground.

10. An electronic display comprising:
a plurality of pixels, each pixel having a common electrode and a pixel electrode;
a gate driver configured to supply activation signals to the pixels to activate the pixels; and
a source driver configured to supply data signals to the pixel electrodes while the pixels are activated;
wherein, when the display is to be turned off, the gate driver supplies activation signals, the source driver supplies data signals of substantially ground, common electrode voltages of the common electrodes are controlled toward substantially ground, and the gate driver removes the activation signals after the common electrode voltages reach substantially ground.

11. The electronic display of claim 10, wherein each of the pixels comprises an oxide thin-film transistor and the gate driver is configured to supply activation signals to a gate of each oxide thin-film transistor.

12. The electronic display of claim 10, comprising a resistive device coupled between a gate driver voltage input and ground, wherein the gate driver removes the activation signal by discharging power through the resistive device.

13. The electronic display of claim 10, comprising a resistive device coupled between the common electrodes and ground, wherein the common electrode voltages of the common electrodes are controlled toward substantially ground by discharging power through the resistive device.

14. The electronic display of claim 13, wherein discharging power through the resistive device discharges voltages stored on the pixels.

15. An electronic device comprising:
a housing;
a processor disposed within the housing;
one or more input structures configured to transmit input signals to the processor; and
an electronic display coupled to the housing and configured to discharge pixels of the electronic display to be turned off, wherein discharging the pixels comprises controlling data signals and common electrode voltages toward substantially ground while an activation signal is supplied to the pixels and removing the activation signal after the data signals and the common electrode voltages reach substantially ground.

16. The electronic device of claim 15, comprising a power management device configured to provide a high gate voltage and a low gate voltage to a gate driver of the electronic display.

17. The electronic device of claim 16, comprising a resistive device coupled between the high gate voltage and ground, wherein the gate driver is configured to couple an input that receives the high gate voltage to an output that provides the activation signal as a result of power off conditions being detected.

18. The electronic device of claim 15, comprising a power management device configured to control the common electrode voltages.

19. The electronic device of claim 15, comprising a power management device having a solid state device configured to control the common electrode voltages.

20. The electronic device of claim 15, comprising a power management device having a solid state device configured to control removal of the activation signal.
